(19) United States
(12) Patent Application Publication
(10) Pub. No.: US 2012/0110769 A1
(43) Pub. Date: May 10, 2012

(54) TROWEL WITH EASY ASSEMBLY AND EASILY REPLACEABLE BLADE

(76) Inventor: Wen-Chen LIN, Taichung City (TW)

(21) Appl. No.: 12/940,206

(22) Filed: Nov. 5, 2010

(51) Int. Cl. B05C 17/10

(52) U.S. Cl. 15/245.1

(57) ABSTRACT

The invention is related to a trowel that can be easily assembled and replaced for blade. The trowel comprises a handgrip shank and a knife holder that can accommodate a blade. The knife holder has a crossing locking groove inside and its top is firmly attached to the top of the supporting surface of the shank by fasteners. Thus, a suitable gap is formed between the bottom of the knife holder and the supporting surface. As a result, when the knife back has multiple locking hooks apart in equal distance, the blade can use knife back to slide in from the knife holder side and be locked inside the locking groove with the locking hooks. This provides a firm assembly positioning without downward detachment. In addition, the blade can be quickly removed from the knife holder side for replacement.

### BACKGROUND OF THE INVENTION

1. Field of the Invention

The invention is related to a tool for remodeling and patching holes or cracks on wall surface. Especially, it refers to a trowel that can be easily assembled and replaced for blade. It mainly provides mechanism between trowel blade and shank for fast and simple assembly and replacement.

2. Description of the Prior Art

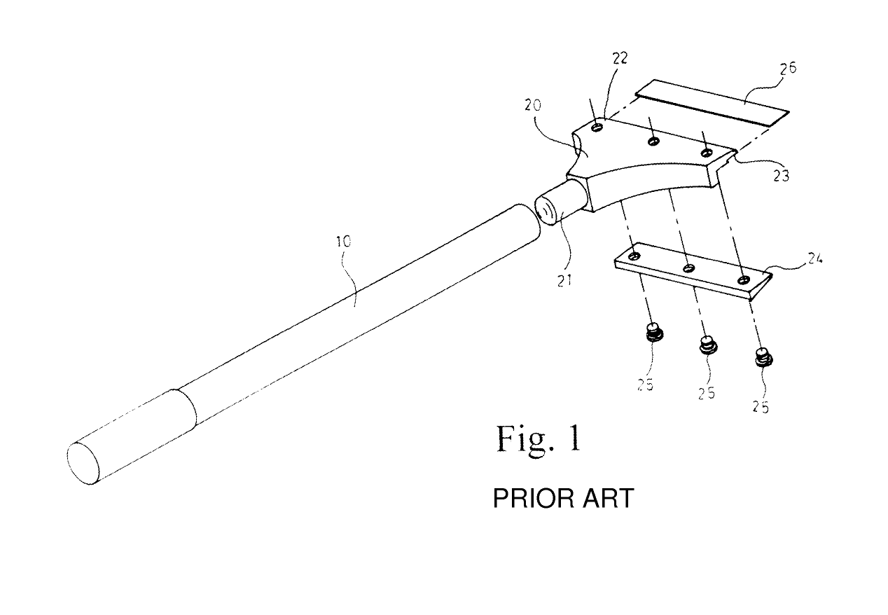

The wallpaper or paint job in remodeling needs patching holes or cracks to smoothen surface and deliver flat surface after wallpaper or paint job is completed. Please refer to FIG. 1 for the structure of a known trowel. The trowel generally comprises a handgrip shank 10 and a knife holder 20 in the front. The back end of the knife holder 20 forms an insert head 21 that can connect with the shank 10. The front of the knife holder 20 forms a jaw 22 and a clip slot 23, which can work with a clip jaw 24 and several screws 25 apart in certain distance to provide tightening for clip jaw 24 to secure a blade 26 inside the clip slot 23 and stick the blade 26 in the front of the jaw 22. Therefore, this configuration allows user to handgrip the shank 10 and use the blade 26 to patch holes or cracks on wall and deliver flat wall surface in remodeling work. However, further investigation into the above mentioned known trowel blade reveals the following drawbacks:

First, the blade 26 is assembled inside the clip slot 23 of the jaw 22 with several screws 25 to pass through the clip jaw 24 and secure the blade 26. The tightening force in the back is vertically deviated from the blade 26. As a result, after strong scraping action, the assembly may loosen and the trowel blade 26 may come off.

Second, the blade 26 is assembled inside the clip slot 23 of the jaw 22 with several screws 25 to pass through the clip jaw 24 and secure the blade 26. As a result, after repeated scraping action, the blade 26 may wear out and can no longer be used. Then, replacing blade 26 will not be an easy task.

The invention seeks improvement for the known trowel that there are the above drawbacks in assembly and replacement with the blade 26 and the knife holder 20. This is also the motivation for the invention.

### SUMMARY OF THE INVENTION

Therefore, the objective for the invention is to provide a trowel which assembly and blade replacement are simple and easy. It is mainly to put a knife holder above the supporting surface extended from the shank, so a locking groove inside the knife holder can accommodate a blade in position without downward detachment by a simple locking mechanism on the side of a locking groove of the knife holder in the knife back. And the blade can be quickly replaced from the knife holder.

Another objective for the invention is to provide a trowel for simple and easy blade replacement. The trowel shank is formed in one piece with top grip and bottom supporting surface, so the proper angle between the grip and the supporting surface can provide trowel user with easy handling and strong support when patching holes and cracks.

To achieve the above objective, the trowel in the invention that provides simple and easy blade replacement comprises a handgrip shank and a blade accommodating knife holder. Inside the knife holder there is a crossing locking groove, which top is fixed by fasteners onto the supporting surface extended from the shank. Thus, between the knife holder bottom and the supporting surface there are appropriate insert gaps. The knife back also has several locking hooks apart in equal distance. Therefore, the blade can slide in through the gap between the knife holder on the knife back and the supporting surface of the shank. The blade can be secured in the locking groove on the knife holder by the locking hooks, so the blade is assembled in place without detachment and can be quickly removed from the knife holder side for replacement. When the blade is positioned inside the knife holder, the supporting surface extended from the shank provides proper support to the blade back. Particularly, in scraping action, the supporting surface of the shank can reinforce the blade to prevent deformation.

### DETAILED DESCRIPTION OF THE INVENTION

The following describes the characteristics of the invention with illustrations for an embodiment:

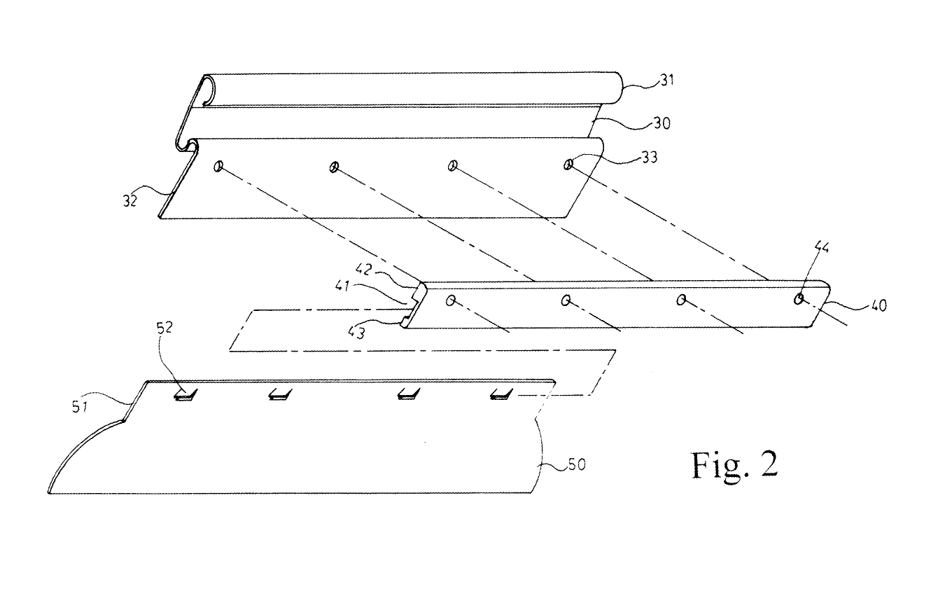

Please refer to FIG. 2 for an external disassembly diagram for the trowel that provides easy and simple blade replacement. The trowel generally has a handgrip shank 30 and a knife holder 40 to accommodate a blade 50 in a simple and easy fashion. Among all

The shank 30 is formed in one piece with a grip 31 and extends downward to forms a supporting surface 32. A proper angle is formed between the grip 31 and the supporting surface 32 for handgrip. Above the supporting surface 32 there are combination holes 33 apart in equal distance.

Inside the knife holder 40, there is a crossing locking groove 41 to divide the knife holder 40 into top combinative end 42 and bottom seam end 43. The combinative end 42 has higher thickness than the seam end 43. The combinative end 42 has combination holes 44 corresponding to the combination holes 33 on the shank 30 supporting surface 32.

Above the blade 50 there is a knife back 51, which has several locking hooks 52 apart in equal distance. The locking hooks 52 are formed on the knife back 51, so one end is connected to the base material and the other end parallel curving up in tabular form.

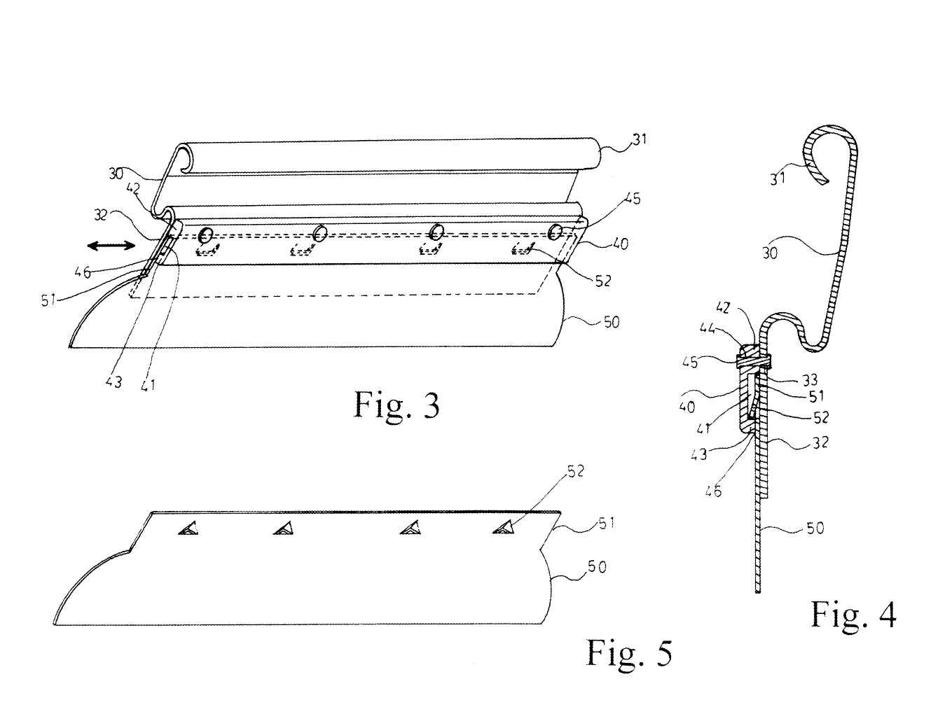

Please refer to FIG. 3 and FIG. 4 for the external assembly diagram and the cross-sectional diagram for the trowel that can be easily assembled and replaced for blade in the invention. First, the knife holder 40 uses fasteners 45 to pass through its combination holes 44 and the combination holes 33 on the shank 30 supporting surface 32, so the combinative end 32 of the knife holder 40 can firmly attach to the top of the shank 30 supporting surface 32. Then, because the seam end 43 in the bottom of the knife holder 40 has lower thickness and appears floating on the shank 30 supporting surface 32, there forms a proper insert gap 46. When the blade 50 uses its knife back 51 to slide in from the insert gap 46 on either side between the knife holder 40 and the shank 30 supporting surface 32, the knife back 51 can be locked inside the locking groove 41 of the knife holder 40 by locking hooks 52 and assembled in place without downward detachment. In addition, the blade 50 can also be easily removed from the knife holder 40 side. In scraping action, the shank 30 supporting surface 32 provides suitable support on the back of the blade 50 and reinforces the blade 50 without deformation.

Please refer to FIG. 5 for another embodiment for the invention. In this embodiment, the multiple locking hooks 52 on the blade 50 are formed on the knife back 51 and appear as triangle tabs curving up. The blade 50 can use the triangle locking hooks 52 to be locked inside the locking groove 41 of the knife holder 40. Thus, the blade 50 does not detach downward and is firmly assembled on the shank 30. In addition, the blade 50 can be quickly removed from the side of the knife holder 40.

The above disclosed figures and description are only for one embodiment of the invention. The equivalent modification or application by those who are familiar with this technique, such as forming cracking and curving end on the knife back into a locking hook is not limited by the invention and shall be included within the scope of claims for the invention.

### Specific Drawing:

(1) The designated diagram for the present invention is FIG. 2.)

(2) The legends for the components)

| | | | | | |
|---|---|---|---|---|---|
| 30 | shank | 31 | grip | 32 | supporting surface |
| 33 | combination hole | 40 | knife holder | 41 | locking groove |
| 42 | combinative end | 43 | seam end | 44 | combination hole |
| 50 | blade | 51 | knife back | 52 | locking hook |

### BRIEF DESCRIPTION OF THE DRAWINGS

FIG. 1 is the structure for a known trowel.

FIG. 2 is the external disassembly diagram for a trowel that can be easily assembled and replaced for blade.

FIG. 3 is the assembly diagram for the trowel that can be easily assembled and replaced for blade in the invention.

FIG. 4 is the cross-sectional view for the trowel that can be easily assembled and replaced for blade in the invention.

FIG. 5 is another feasible embodiment for the blade in the invention.

What is claimed is:

1. A trowel that can be easily assembled and replaced for blade comprises a shank, a knife holder and a blade:
the shank is formed in one piece with a curved grip in the top and a supporting surface extending to the bottom; above the supporting surface there are several combination holes apart in equal distance;
the knife holder has a crossing locking groove inside; above the locking groove there is a combinative end; below the locking groove there is a seam end; there are corresponding combination holes on the combinative end;
above the blade there is a knife back with multiple locking hooks apart in equal distance;
through the above components, a trowel is constituted for easy assembly and replacement for blade.

2. As in claim 1 for a trowel that can be easily assembled and replaced for blade, the knife holder uses fasteners to pass through the combination holes and is firmly attached onto the supporting surface of the shank. The combinative end above the knife holder is thicker than the seam end below and this allows an insert gap formed between the seam end and the supporting surface of the shank.

3. As in claim 1 for a trowel that can be easily assembled and replaced for blade, the blade uses knife back to slide into the assembly from the insert gap on either side between the knife holder and the supporting surface of the shank.

4. As in claim 1 for a trowel that can be easily assembled and replaced for blade, the blade uses the locking hooks on the knife back to lock into the locking groove inside the knife holder and achieves assembly positioning without downward detachment.

5. As in claim 1 for a trowel that can be easily assembled and replaced for blade, the locking hook of the blade is formed from the knife back material, so one end is connected to the base material and the other end parallel curving up in tabular form.

6. As in claim 1 for a trowel that can be easily assembled and replaced for blade, the locking hook of the blade is formed from the knife back material, so one end is connected to the base material and the other end parallel curving up in triangle form.

7. As in claim 1 for a trowel that can be easily assembled and replaced for blade, the assembly of the blade and the shank enables the supporting surface to provide suitable supporting force on the back of the blade.

8. As in claim 1 for a trowel that can be easily assembled and replaced for blade, the shank is formed in one piece with top grip and bottom supporting surface, so an angle is formed and suitable for grip and exerting force between the grip in the top and the supporting surface in the bottom.
